(19) United States
(12) Patent Application Publication
(10) Pub. No.: US 2026/0161371 A1
(43) Pub. Date: Jun. 11, 2026

(54) Enhancing a Code Base using Dynamic Retrieval-Augmented Generation (RAG) with Run-Time Prompt Enrichment

(71) Applicant: Zscaler, Inc., San Jose, CA (US)

(72) Inventors: Saurav Shyju, Bengaluru (IN); Golla Sai Venkatesh, Bengaluru (IN)

(73) Assignee: Zscaler, Inc., San Jose, CA (US)

(21) Appl. No.: 19/052,365

(22) Filed: Feb. 13, 2025

(30) Foreign Application Priority Data
Dec. 10, 2024 (IN) 202441097354

(51) Int. Cl. G06F 8/35

(52) U.S. Cl. CPC G06F 8/35

(57) ABSTRACT

Systems and methods for enhancing software code are provided. A method, according to one implementation, includes receiving a code base developed by one or more software developers and receiving a prompt for requesting enhancement to the code base. Also, the method includes a step of using a dynamic Retrieval-Augmented Generation (RAG) component and a Knowledge Base (KB) repository to enrich the prompt. Based on the enriched prompt, the method further includes a step of using a Large Language Model (LLM) code enhancing tool to enhance the code base.

### TECHNICAL FIELD

The present disclosure generally relates to networking systems and methods. More particularly, the present disclosure relates to enhancing a code base developed by a software developer, where the code base is enhanced using dynamic Retrieval-Augmented Generation (RAG) associated with a Large Language Model (LLM), the dynamic RAG further implementing run-time prompt enrichment.

### BACKGROUND

Software developers consider GitHub Copilot to be a useful tool for enhancing code. Copilot provides AI-assisted coding suggestions in real-time, which can significantly boost productivity, improve code quality, and assist with problem-solving. Also, Copilot can help speed up the coding process by suggesting entire lines or blocks of code based on the context of code as it is being written. It can also handle mundane tasks, like boilerplate code or repetitive structures, allowing developers to focus more on complex logic and problem-solving. Additionally, it can suggest language features, libraries, or best practices that a developer may not be familiar with. Copilot can work with many different programming languages, such as Python, JavaScript, TypeScript, Ruby, Go, etc., and can help reduce syntax errors and other common mistakes. Like other AI-assisted tools, however, Copilot can sometimes generate incorrect or suboptimal code. Therefore, developers still need to use their coding skills to verify the suggested code to ensure it meets their requirements and needs.

### BRIEF SUMMARY

The present disclosure is directed to systems and methods for enhancing software code. In one implementation, a method includes a step of receiving a code base developed by one or more software developers and a step of receiving a prompt for requesting enhancement to the code base. The method further includes using a dynamic Retrieval-Augmented Generation (RAG) component and a Knowledge Base (KB) repository to enrich the prompt. Based on the enriched prompt, the method also includes using a Large Language Model (LLM) code enhancing tool to enhance the code base.

According to some embodiments, the method may include steps of a) compressing the code base enhanced by the LLM code enhancing tool and b) caching the code base in an accessible central cache. In some embodiments, the dynamic RAG component may use dynamic dependency functionality to determine relevant in-context information related to the prompt. Also, a virtual LLM (vLLM) may be configured in some implementations to assist the LLM code enhancing tool with respect to inference and memory allocation functions. The method may further include a step of using an Integrated Development Environment (IDE) plugin module for assisting a user with entry of the code base and prompt.

In some embodiments, the KB may be configured to store proprietary code symbols. The dynamic RAG component, for example, may be configured to construct a code dependency tree from the proprietary code symbols during run-time and supply the code dependency tree to the LLM code enhancing tool. Additionally, the dynamic RAG component may be configured to use metadata extracted from the KB to convert the code base into an Abstract Syntax Tree (AST) and identify code symbols in the code base by querying the AST using an exact match query of the KB.

According to some implementations, the action of enhancing the code base may include a) improving readability of the code base, b) compressing or reducing redundancy of the code base, c) optimizing the code base, d) repairing the code base to reduce or eliminate errors or security issues, e) generating test automation unit test code for the code base, and/or f) creating documentation, functional explanations, and/or comments applicable to the code base. Also, the LLM code enhancing tool, in some cases, may be configured to utilize CodeLlama 34B Instruct trained with 500B code tokens.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIGS. 1A, 1B, 2A, 2B, 3A, and 3B are block diagrams illustrating code development systems, according to various embodiments.

FIG. 4 is a block diagram illustrating a system for creating a code dependency tree for providing relevant context from code symbols, according to various embodiments.

FIG. 5 is a block diagram illustrating a system for identifying and tagging code blocks for on-demand retrieval, according to various embodiments.

FIG. 6 is a block diagram illustrating a computing system of a code enhancement tool, according to various embodiments.

FIG. 7 is a flow diagram illustrating a method for enhancing software code, according to various embodiments.

FIG. 8 is a diagram illustrating a knowledge graph having nested code chunks, according to various embodiments.

### DETAILED DESCRIPTION

The present disclosure relates to systems and methods associated with the use of Large Language Models (LLMs) for enhancing or enriching software code (or a code base) that is developed by a software developer or engineer. LLMs are machine learning models that are popular for their ability to generate general-purpose text content over a broad range of topics. A language model is often trained over a proprietary dataset of curated texts (also known as “corpus”) and deployed to generate synthetic text by providing an input and automatically generating relevant outputs. An LLM is a version of a language model where the training corpus includes the entire publicly available Internet. This huge corpus enables an LLM to generate synthetic content over a vast number of topics and fields with remarkable quality from just a small input to start off.

Although LLMs can quickly generate a lot of content based on a simple input, when an LLM is prompted to generate a synthetic text on a topic or a field that has never been remotely encountered by the LLM during its training routine, LLMs often start hallucinating. That is, it will assume the unknown to be something that may not be accurate to the original content and generate content based on this false assumption. More often than not, such cases of hallucinations can be treated by explicitly providing specific “context” of any potentially unknown topics that need to be generated. This method of educating the LLM about a particular topic during run-time is called “in-context learning” and is a popular method to overcome hallucination.

Expanding on the idea of in-context learning, injecting appropriate knowledge to the LLM for any arbitrary query can be automated by Retrieval-Augmented Generation (RAG), wherein, the input query is used to find relevant chunks of proprietary information from an indexed database of custom knowledge (also known as a Knowledge Base (KB)). This retrieval is based on a concept referred to as a “vector search,” where all information is embedded into a vector space. This vector space can embed knowledge in a high dimensional space (i.e., having multiple various). Search queries may use Approximate Nearest Neighbor (ANN) algorithms to find similar content using a closeness factor. That is, similar content often ends up nearer to each other in the vector space. This behavior of the KB in the vector space allows an automatic approach in retrieval and injection of relevant information through similarity search by proximal knowledge capturing. This strategy has expanded the use cases of LLMs beyond general purpose content generation to involve more proprietary KBs.

Using LLMs for generating code is also a prominent area where users can automate writing code by simply providing high level instructions. Use-cases such as test-code generation, code-analysis and document generation are popularly substituted by an LLM to be automated. In cases where the code/library requires to be built or processed on top of existing proprietary code or has to be referred to, LLMs quickly become obsolete due to its inability to understand the context of libraries used in the input code. While semantic search is a conventional practice in RAG and has its value in many use cases for code generation by “copilots” (e.g., GitHub Copilot), exact match of the dependencies (e.g., as described in various embodiments herein) can provide reliable and trustworthy context information to enrich the prompt.

On the other hand, many conventional LLMs also have a limitation to the size of input it can ingest and output it can generate which greatly restricts in-context learning capabilities as the knowledge retrieval on demand can exceed the theoretical capacity of the LLM. Therefore, the embodiments of the systems and methods described herein are configured to further improve in-context learning with respect to conventional LLM systems.

In addition, conventional LLM systems may result in further problems in LLM based code-content generation, such as:
1. Lack of context for the code input which causes hallucinations;
2. Inaccurate retrieval of knowledge for the given code input from KBs due to the use of semantic search (similarity search);
3. Large size of retrieved knowledge inhibiting quality content generation and sometimes, halting generation; and
4. Slowness in compressing/summarizing large code chunks on-demand to fit into context size limits.

The systems and method of the present disclosure are configured to introduce “dynamic RAG” for code enhancement LLMs. The present disclosure describes frameworks for run-time prompt enrichment through dynamic dependency analysis as well as quick and accurate extraction of metadata from a repository to improve code quality generated by a large language model and reduce hallucination.

Dynamic dependency analysis, as described herein, may refer to methods of analyzing a software program's execution to understand the dependencies between operations. This process may be a quantitative analysis that may be key to computer architecture design. Also, dynamic dependency analysis may include the following processes:
1. Data collection—Before analyzing a program, dynamic dependency analysis collects certain execution data;
2. Distributed programs—Analyzing a distributed program can be challenging because of practical barriers;
3. Program Execution—Program Execution May Contain Characterizing the dependencies; and
4. Parallelism—Executing a program with consistent (not bursty) parallelism.

Dynamic dependency analysis can be used to construct a dynamic execution graph that characterizes a program's execution, study parallelism in programs, understand the inter-dependencies between processes and services across multiple hosts, monitor dynamic cloud dependencies, among other operations.

### Systems for Developing Software Code

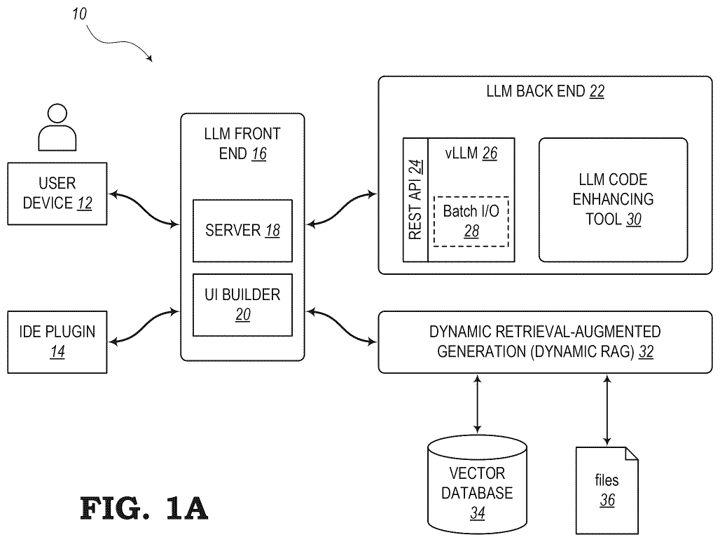

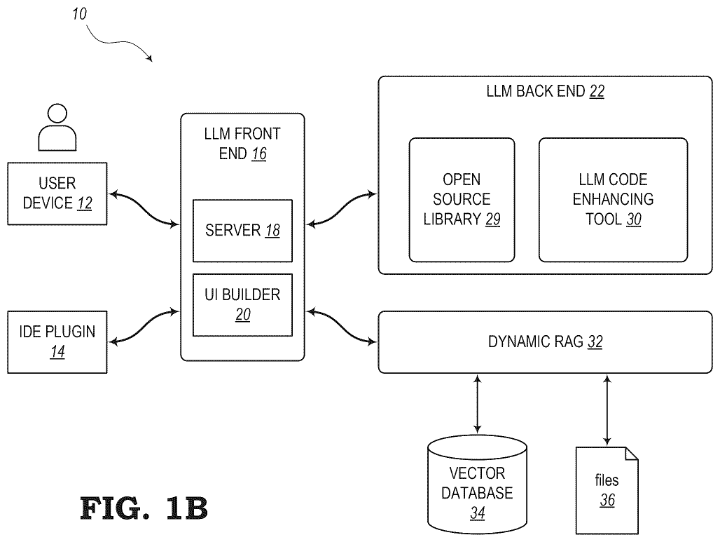

FIG. 1A is a block diagram illustrating an embodiment of a code development system 10, which is configured to receive a code base from a software developer (user) and enhance or enrich the code as needed. The code development system 10 includes a user device 12 allowing a developer to enter software code to be enriched plus enter queries or prompts to enable an LLM to perform the enhancements. Also, the code development system 10 includes an Integrated Development Environment (IDE) plugin 14 (or multiple IDE plugins). Input from the user device 12 and IDE plugin 14 are applied to an LLM front end 16.

The LLM front end 16 includes a server 18 and a UI builder 20 configured for interfacing between the entry of developer code, queries, prompts, etc. and back end processing. The LLM front end 16 is connected to an LLM back end 22, which includes a REST API 24 for enabling communication, a virtual LLM (vLLM) 26 that includes a batch I/O component 28, and an LLM code enhancing tool 30. In addition, the LLM front end 16 is configured to communicate with a dynamic Retrieval-Augmented Generation 32 (or dynamic RAG). The dynamic RAG 32 is arranged in communication a vector database 34, files 36 (e.g., proprietary information), and other sources of information.

FIG. 1B is a block diagram illustrating another embodiment of the code development system 10, which again may be configured to receive a code base from a software developer (user) and enhance or enrich the code as needed. The code development system 10, in the embodiment of FIG. 1B, may include many of the same or similar components as shown in FIG. 1A. However, the specific elements shown in FIG. 1A may be substituted with generalized components in various embodiments. For example, the LLM back end 22 may be configured with an open source library 29 operating with the LLM code enhancing tool 30. Although the open source library 29 may include vLLM features, other implementations may also be incorporated in the code development system 10. The open source library 29 may be configured to serve the LLM in the LLM back end 22. The open source library 29 may be referred to as a) an instance of a framework/library used to serve the LLM in the LLM back end 22, or b) an instance of the LLM itself. Multiple solutions for these two instances may be realized in the embodiment of the code development system 10 and can utilize different frameworks. The LLM may include Llama 3.1 70B Instruct, for example, or other suitable models. The open source library 29 may include SGLang, for example, or other suitable libraries.

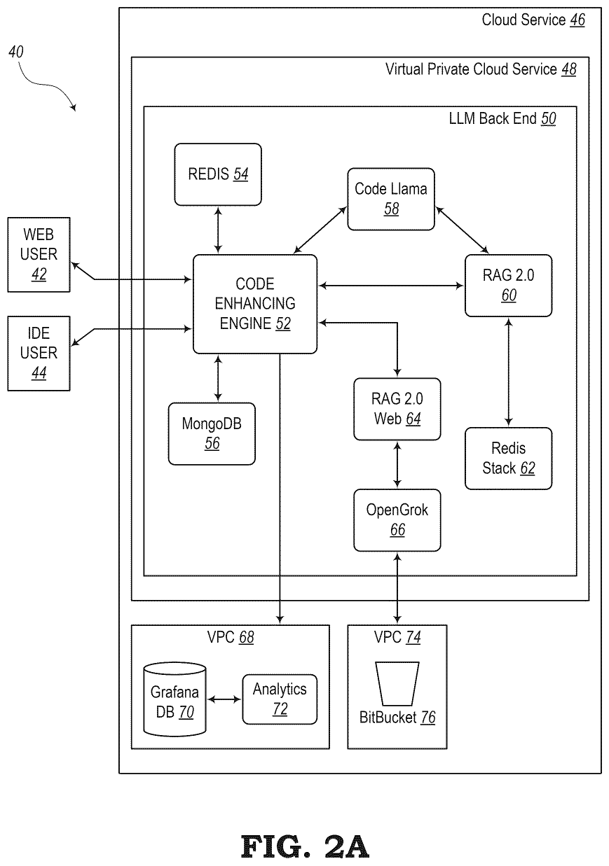

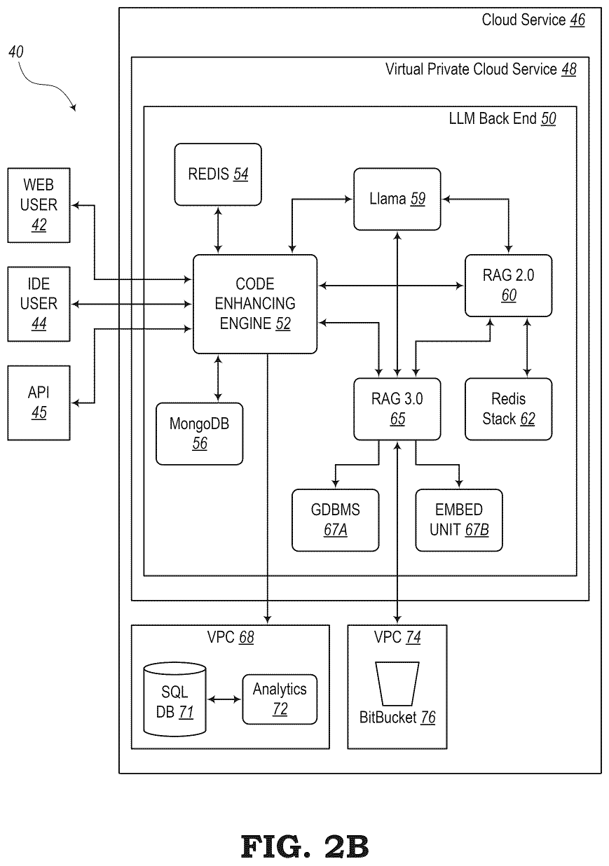

FIG. 2A is a block diagram illustrating an embodiment of another code development system 40. As shown in this embodiment, the code development system 40 includes a device for receiving input from a web user 42 and an IDE user 44. The code development system 40 is incorporated overall in a cloud service 46. Part of the cloud service 46 includes a virtual private cloud service 48. Additionally, the virtual private cloud service 48, according to this embodiment, includes an LLM back end 50 (e.g., the same as or similar to the LLM back end 22 shown in FIGS. 1A and 1B), among other services.

The LLM back end 50 in this embodiment includes a code enhancing engine 52, which is arranged as a central controlling element of the LLM back end 50 for processing a developed code base to enhance or enrich the code as needed. The LLM back end 50 further includes a Redis (Remote Dictionary Server) component 54 and a MongoDB component 56. The Redis component 54 can be used as a distributed, low-latency, in-memory storage, database, cache, etc. The Redis component 54 may be configured to support different kinds of abstract data structures, such as a code base, doc strings, lists, maps, sets, bitmaps, streams, etc. The MongoDB component 56 may be a source-available, cross-platform, document-oriented database program that may utilize JSON-like documents with optional schemas.

Also, the LLM back end 50 includes a Code Llama component 58 and a RAG 2.0 component 60. The Code Llama component 58 may include an advanced code-focused LLM, using a model that may be configured to fill in code as needed, handle extensive input contexts, and follow programming instructions without prior training. For example, the Code Llama component 58 may be configured as a CodeLlama 34B Instruct component, which may use a natural language processing model for following code, safely deploying code, providing code explanations, and various other code generation and handling functions.

The RAG 2.0 component 60, in turn, is connected to a Redis Stack component 62. The Redis Stack component 62 may be configured to combine capabilities of Redis modules into a single platform for building real-time applications. The Redis Stack component 62 may include features like JSON, search and query, time series, probabilistic data structures, and may be configured to simplify the developer experience by unifying Redis features in a quick and reliable manner.

The code enhancing engine 52 is further connected to a RAG 2.0 Web component 64, which in turn is connected to an OpenGrok component 66. The OpenGrok component 66 may be configured as a source code cross-reference and search engine for helping a programmer search, cross-reference, and navigate source code trees to aid program comprehension.

Also, the code enhancing engine 52 is connected to a Virtual Private Cloud (VPC) 68 in the cloud service 46. The VPC 68 includes, among other things, a Structured Query Language (SQL) database component 70 (such as GrafanaDB) and an Analytics component 72. The SQL database component 70 may be used to store users, hits, and other persistent data for analytical purposes.

Furthermore, the OpenGrok component 66 of the LLM back end 50 is connected to another VPC 74 in the cloud service 46. The VPC 74, for example, may include a BitBucket component 76. The BitBucket component 76 may be configured as a Git-based source code repository that can allow software developers to perform basic Git operations (e.g., reviewing or merging code) while controlling on-premises read and write access to the code.

FIG. 2B is a block diagram illustrating another embodiment of the code development system 40. As shown in this embodiment, the code development system 40 receives input from the web user 42, the IDE user 44, and an API 45. Again, the code development system 40 may be incorporated in the cloud service 46, where part of the cloud service 46 includes the virtual private cloud service 48 and part of the virtual private cloud service 48 includes the LLM back end 50. In some embodiments, the code enhancing engine 52 may be configured to store command-line utilities, job schedulers, and other types of data (e.g., cron) in a SQL database 71 of the VPC 68. For example, a cron command-line utility may be used to set up and maintain software environments for scheduling jobs (i.e., cron jobs) to run periodically.

The components of the code development system 40 of FIG. 2A may be substituted with generalized components in some cases. The LLM back end 50, in the embodiment of FIG. 2B, may include many of the same or similar components as shown in FIG. 2A. However, the specific elements shown in FIG. 2A may be substituted with generalized components in various embodiments. For example, the LLM back end 50 may include an LLM, such as Llama 59, which may include Llama 3.1 70B Instruct, for example, or other suitable models. Also, the LLM back end 50 in this embodiment may include a RAG 3.0 component 65 in communication with the code enhancing engine 52 and RAG 2.0 component 60. In addition, the RAG 3.0 component 65 may include a tool calling connection with the Llama 59.

The RAG 3.0 component 65 may exchange dependency information with the RAG 2.0 component 60. Furthermore, the RAG 3.0 component 65 is configured in communication with the VPC 74 to store data (e.g., Cron). The RAG 3.0 component 65 may further provide outputs to a Graph Database Management System (GDBMS) 67A and an embedding unit 67B. The GDBMS 67A may be configured as Neo4j or other suitable components. In some embodiments, the RAG 3.0 component 65 and GDBMS 67A may exchange knowledge inputs/outputs as well as other types of data elements. These data elements may be stored in the GDBMS 67A as nodes, edges connecting the nodes, and/or attributes of the nodes and edges. Also, the embedding unit 67B may be configured to store embedded vectors in a vector database.

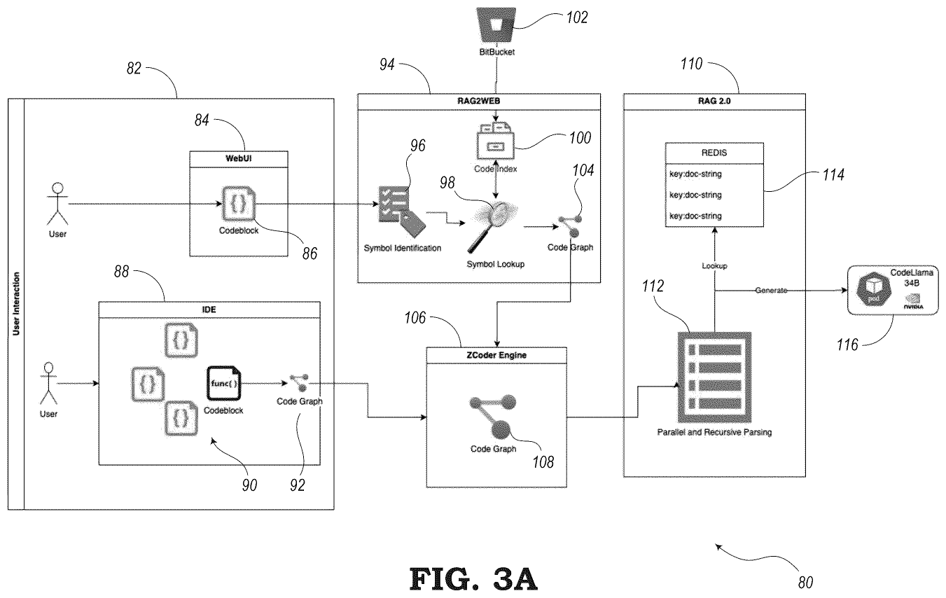

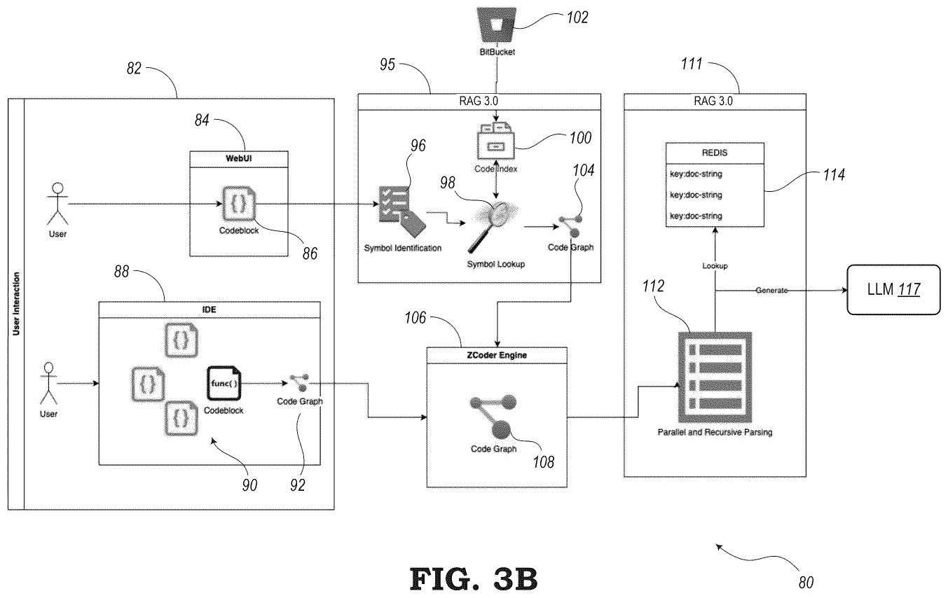

FIG. 3A is a block diagram illustrating an embodiment of yet another code development system 80. In this embodiment, the code development system 80 includes a user interaction environment 82. The user interaction environment 82 includes a WebUI component 84, which is configured to receive a code block 86 from a user (or software developer). Also, the user interaction environment 82 includes an IDE component 88, which is configured to receive code blocks 90 from a user, where a function of the code blocks 90 can be performed to create a code graph 92.

The code development system 80 further includes a RAG2WEB component 94. The code block 86 is applied to a symbol identification component 96 of the RAG2WEB component 94. Upon symbol identification, the code is passed to a code index component 100, which is configured to search code information from an external BitBucket component 102 and pass the results back to the symbol lookup component 98. Next, the code is passed to a code graph component 104 for creating a code graph.

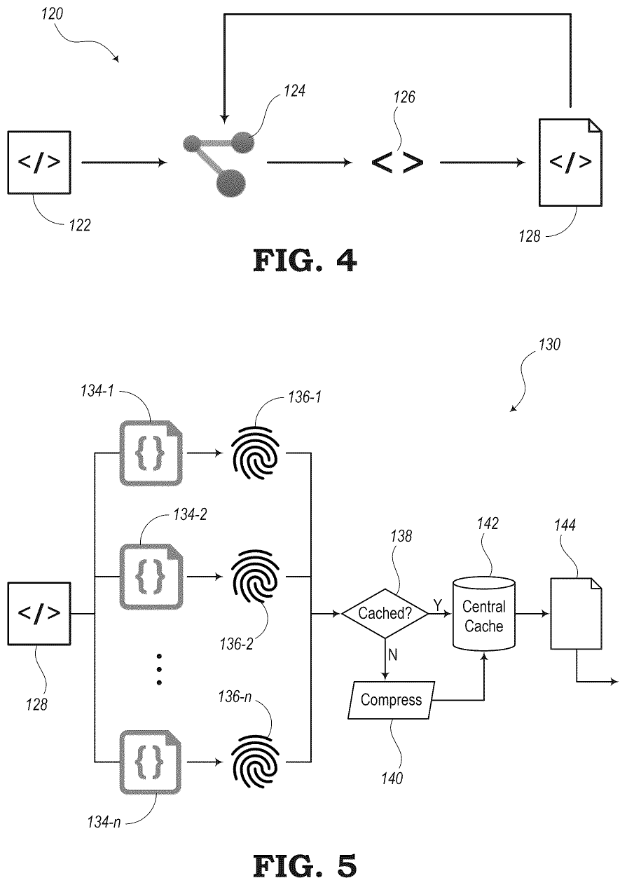

Also, the code development system 80 includes a coder engine 106 (e.g., “ZCoder” engine associated with Zscaler, Inc.). The coder engine 106 includes a code graph component 108 that is configured to combine the code graph 92 from the IDE component 88 and the code graph 104 from the RAG2WEB component 94. The cumulative code graph of the code graph component 108 is passed to a RAG 2.0 component 110 of the code development system 80. The RAG 2.0 component 110 includes a parallel and recursive parsing component 112, which is configured to perform parsing actions, such as those described below with respect to FIG. 4. The results of the parsing actions are passed to a Redis component 114 to lookup doc-string information and then passed to a Code Llama component 116 (e.g., Code Llama 34B, Code Llama 34B Instruct, etc.) for generating the enhanced software code.

FIG. 3B is a block diagram illustrating another embodiment of the code development system 80. The code development system 80, in the embodiment of FIG. 3B, may include many of the same or similar components as shown in FIG. 3A. However, the specific elements shown in FIG. 3A may be substituted with generalized components in various embodiments. For example, the Code Llama component 116 may instead include a general LLM 117, such as a Llama 3.1 70B Instruct component or other suitable models. Also, the RAG2WEB component 94 may be replaced in some embodiments with a RAG 3.0 component 95, as shown in FIG. 3B. Also, the RAG 2.0 component 110 shown in FIG. 3A may be replaced with a RAG 3.0 component 111, as shown in the FIG. 3B.

### RAG 3.0

It may be noted that the term “RAG 3.0” used in the present disclosure does not necessarily refer to any specific standard or protocol that currently exists or may exist in the future, although it may include some or all features developed beyond RAG 2.0. Instead, “RAG 3.0” may include various RAG features that are described in the present disclosure. Therefore, RAG 3.0 may include the following features and/or other features described herein.

Conventional LLMs generally lack knowledge about proprietary knowledge sources, such as code repositories, help docs, RCAs. If prompted to generate content based on this knowledge, conventional RAG-based approaches tend to fail due to their inability to capture and retrieve adequate information in an LLM-friendly manner.

Regarding business value and impact, RAG-based approaches may be characterized by:
1) Increased Accuracy of Code Generation When Dealing With Proprietary Repositories.
2) Testing teams: Can get tailored test cases (e.g., Test Style). Conventional RAG solutions might enrich the prompt with adequate dependency information, but they typically lack test style knowledge, deeper understanding of the codebase and normally only have code syntax information.
3) Customer Reliability Engineering (CRE) teams: Search and ask questions about repository (repo) code symbols to get an understanding of what an arbitrary symbol does in a codebase without having to go through the entire code base.
4) Q&A about the repo functions: General Q&A about the codebase for understanding what each module/element of code is about. This makes life easier for inexperienced users to get started.
5) External Knowledge Source: General Q&A about other textual knowledge sources such as a) Help Docs, b) Design Docs (e.g., jira-field from stories→dump to data lake), c) Confluence (in some spaces), d) JIRA (e.g., JQL based tools), which may enable engineers to have a one stop solution for Zscaler queries.

Therefore, according to some proposed solutions as described in the present disclosure, the LLM can be provided with full repo knowledge on demand. This may include not only “global regular expression print” (grep) symbols that can be fed into an LLM, but also it might lose dependency info and any other info it may require about the code.

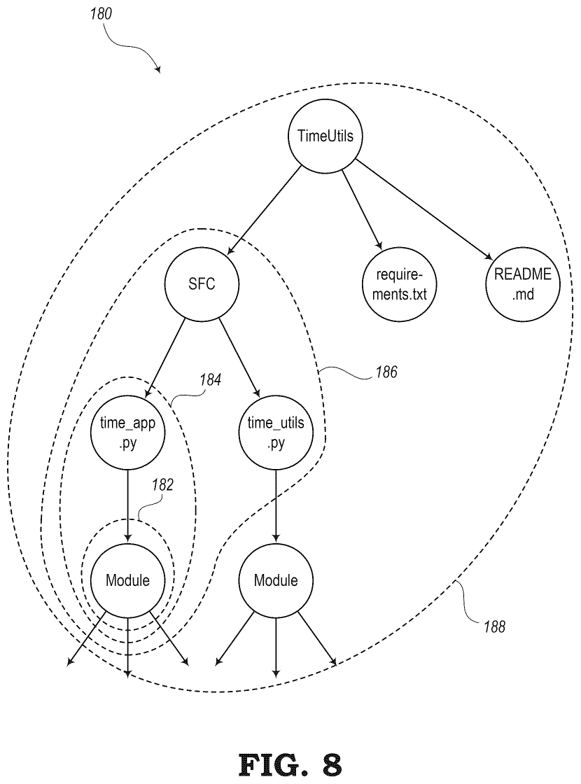

In one embodiment, a solution may include:
1) Parse the entire repo on syntactic and semantic level.
2) Chunk code on multiple levels.→Symbols, Lines, functions, modules, classes, libraries, parent files. Store as a graph with code linkage as reference. Construct a Knowledge graph based on code linkage and enable LLM to traverse the graph, such as is described below with respect to FIG. 8.

### Creating a Code Dependency Tree

FIG. 4 is a block diagram illustrating an embodiment of a system 120 for creating a code dependency tree for providing relevant context from code symbols. In this embodiment, the system 120 includes a code input component 122 for receiving software code from a developer. The code is parsed (e.g., using Tree-sitter) and passed to a syntax tree component 124. A query is passed to syntax tree component 124 to identify the reference code symbols 126. These reference code symbols are queried through language server APIs to get their definitions 128. In a recursive manner, these definitions are parsed and fed back to syntax tree component 124 to identify other reference code symbols 126 for reiterative processing and fine-tuning of the code dependency tree.

When a code input at the code input component 122 includes proprietary code symbols unfamiliar to an LLM, the LLM may start generating inaccurate, unrelated, or hallucinated information without proper context. To address this issue, the system 120 is configured to create a code dependency tree to provide the LLM with relevant context for the referenced symbols. This process involves the syntax tree component 124 converting the input code into an Abstract Syntax Tree (AST). This conversion may use a tree-sitter process, whereby the system 120 may be configured to use a parser generator and incremental parsing library to parse source code into abstract syntax trees usable in compilers, interpreters, text editors, and static analyzers. The tree-sitter function may also include incremental parsing for updating parse trees while code is edited in real time.

The syntax tree component 124 may also identify referenced code symbols by querying the AST and constructing the code dependency tree with each symbol as a node, along with its definition retrieved via Language Server APIs. As these referred symbols may reference other symbols, a recursive approach is employed to establish the code input context using the AST and Language Server APIs. The AST may be configured as a data structure used for representing the structure of the program or code snippet. The AST may be a tree representation of the abstract syntactic structure of text (often source code) written in a formal language. Each node of the syntax tree denotes a construct occurring in the text. The syntax may be “abstract” in the sense that it does not represent every detail appearing in the real syntax, but rather includes just the structural or content-related details. For instance, grouping parentheses are implicit in the tree structure, so these do not have to be represented as separate nodes. Likewise, a syntactic construct like an if-then statement may be denoted by means of a single node with three branches.

### Code Block Fingerprinting

FIG. 5 is a block diagram illustrating an embodiment of a system 130 for identifying and tagging code blocks for on-demand retrieval. In this embodiment, the system 130 includes an input component 128 configured to receive code blocks from a database, repository, etc. The code blocks are fed to a number of function components 134-1, 134-2, . . . , 134-n, which are configured to generate abstractions of the code blocks. The abstracted code symbols from the function components 134-1, 134-2, . . . , 134-n are fed to code identity components 136-1, 136-2, . . . , 136-n (or fingerprint identifiers), respectively, which are configured to generate code identity information.

Next, a process includes determining (decision block 138) if the code block is to be compressed. If the code is not already cached, the code is applied to a compression component 140, which is configured to compress the code and store it in a central cache 142. If the code is already cached, it can bypass the compression component 140 and retrieved directly from the central cache 142. The central cache 142 may be accessible by multiple users (e.g., within an enterprise) and he cache record is used by prompt construction component 144 to provide enriched prompts that can be used to obtain better query results.

To solve the issue of inaccurate context retrieval, the system 130 may be configured to employ exact match search of knowledge chunks. That is, in case of code blocks, information on each abstracted code symbol is retrieved from its parent repository based on its actual definition rather than employing similarity search based approaches that may introduce inaccurate context enrichment. Each of these standalone code blocks may be identified uniquely based on their fingerprint that is generated by the code identity components 136 (or code identity providers). Each code identity provider may be configured to hash a block of text and generate a uniquely identifiable string that can be used to tag this chunk. This fingerprint can be shared across the entire organization. That is, the chunks may be stored centrally for other developers to reuse, thereby speeding up their inference.

Even after relevant context is retrieved, the addition of this data into the context for prompting the LLM may also be challenging as the model itself would normally have a theoretical limit on the input size. Often, the knowledge that is injected into the prompt on demand exceeds this limit. To overcome this, the system 130 is configured to asynchronously generate code abstract and doc string information to compress its memory footprint while still preserving enough information to necessitate accurate mocking ability of the code when used as a dependency in the prompt. Generating such abstraction can also be challenging as quality of the docstrings are normally ensured and LLMs might take time to process such large pieces of text.

To save efforts in time and resources spent in knowledge compression, the generated abstraction is stored and tagged with the code fingerprint to form a cache of doc strings that can be retrieved on demand without having to regenerate them every time thereby saving time and resources. To ensure the docstrings themselves are generated with appropriate context, a code dependency tree is built with every dependent as the node in the tree. These nodes can further have more specific dependencies for which the system 130 can account. Therefore, the system 130 may enforce subtree based processing where each node, when processing, has its related nodes down the tree within the context of the LLM to minimize hallucination. The same or similar strategy can be followed by constructing a code dependency tree for any interaction with the LLM to enrich the prompt quickly and reduce hallucination.

### Computing System

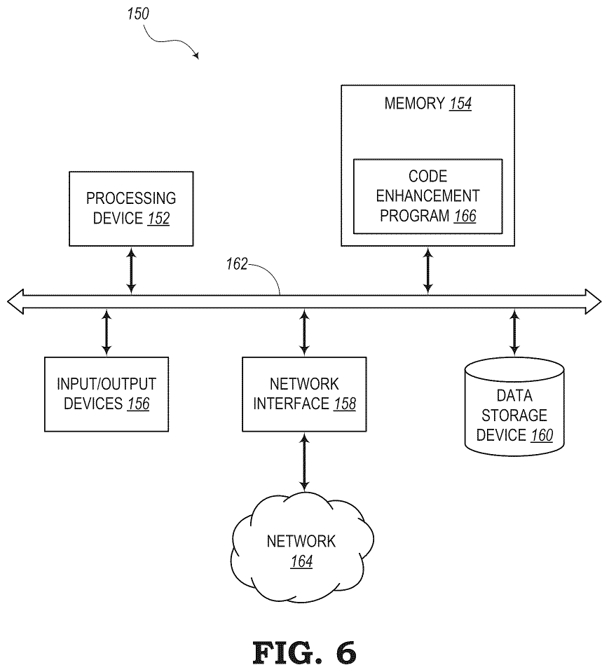

FIG. 6 is a block diagram illustrating an embodiment of a computing system 150 associated with a code enhancement tool. As shown in its simplified form, the computing system 150 includes a processing device 152, memory 154, Input/Output (I/O) devices 156, a network interface 158, and a data storage device 160 (or database), interconnected with each other via a local interface 162 (or bus).

The processing device 152 may include one or more processors or microprocessors, such as a Central Processing Unit (CPU), which is configured to execute instructions and process data. The processing device 152 may be a general-purpose processor, a special-purpose processor, an Application-Specific Integrated Circuit (ASIC), or any combination thereof. The processing device 152 is configured to perform various computational tasks and manage the operations of the computing system 150, including executing software instructions stored in the memory 154. In some embodiments, the processing device 152 may also include or be coupled to a Graphics Processing Unit (GPU), a Digital Signal Processor (DSP), or other specialized processing units that assist in performing specific functions such as image processing, machine learning, or data analysis. The processing device 152 may operate in conjunction with other components of the computing system 150, communicating via the local interface 162.

The memory 154 in the computing system 150 may include any combination of volatile and non-volatile memory components, such as Random-Access Memory (RAM), Read-Only Memory (ROM), flash memory, and other forms of computer-readable storage media. The memory 154 is configured to store software programs, applications, and data that are executed or processed by the processing device 152. The memory 154 may also store an Operating System (O/S) and/or operating instructions that manage the overall operation of the computing system 150. In some embodiments, the memory 154 may be further subdivided into different types, such as main memory (e.g., dynamic RAM) for temporary storage of active data, and secondary memory (e.g., non-volatile memory) for storing data persistently even when the system is powered down. The memory 154 may be dynamically allocated by the computing system 150, and it may be accessible by the processing device 152 and other components via the local interface 162.

The I/O devices 156 allow the computing system 150 to interact with a user, the external environment, and other systems. Input devices may include, but are not limited to, keyboards, mice, touchscreens, microphones, and other sensors or control devices that enable the user to input commands or data into the system. Output devices may include displays, printers, speakers, or haptic feedback devices that allow the computing system 150 to convey information or feedback to the user or external systems. In some embodiments, the I/O devices 156 may also include peripheral devices such as cameras, scanners, or biometric sensors. These I/O devices 156 may be directly connected to the computing system 150 or may communicate with the computing system 150 wirelessly, such as via the network interface 158.

The network interface 158 facilitates communication between the computing system 150 and external networks, such as network 164, a local area network (LAN), a wide area network (WAN), or the Internet. The network interface 158 may include both wired and wireless communication capabilities, such as Ethernet, Wi-Fi, Bluetooth, or other protocols. The network interface 158 enables the computing system 150 to transmit and receive data, connect to remote servers, or access cloud-based services. In some embodiments, the network interface 158 may be integrated with other components of the computing system 150 or implemented as a separate hardware module, and it may support various network protocols, including Transmission Control Protocol/Internet Protocol (TCP/IP), User Datagram Protocol (UDP), and others. The network interface 158 may also provide security features such as encryption, firewalls, and authentication mechanisms to ensure secure communication.

The data storage device 160 is configured to store data persistently, which may include structured data, unstructured data, program files, system logs, and other forms of digital information. The data storage device 160 may take various forms, such as a Hard Disk Drive (HDD), Solid-State Drive (SSD), or other non-volatile memory technologies. In some embodiments, the data storage device 160 is organized as a database, storing records, tables, and indexes that facilitate the efficient retrieval, updating, and management of data. The data storage device 160 may include multiple components and may be local to the computing system 150 and/or connected via a network to external storage resources, such as cloud-based storage platforms. The processing device 152 may interact with the data storage device 160 to retrieve and store data required for executing software applications, maintaining system logs, or providing data for analytical processes.

The various hardware components of the computing system 150, including the processing device 152, memory 154, I/O devices 156, network interface 158, and data storage device 160, communicate with each other over the local interface 162. This local interface 162 may be implemented as a bus, such as a system bus, memory bus, or input/output bus, which provides a communication pathway between the different components. The bus may be based on any standard bus architecture, including but not limited to Peripheral Component Interconnect (PCI), Universal Serial Bus (USB), or Advanced Microcontroller Bus Architecture (AMBA). In some embodiments, the local interface 162 may include multiple buses or communication channels that handle different types of data traffic, such as high-speed data transfers between the memory 154 and the processing device 152, or lower-speed communication with the I/O devices 156 or peripheral devices. The local interface 162 allows for the efficient exchange of data between components and ensures synchronized operation of the system.

The computing system 150 further includes a code enhancement program 166, which may be implemented in any suitable form. For example, the code enhancement program 166 may be configured as software or firmware and stored in the memory 154 or other suitable non-transitory computer-readable media. The code enhancement program 166 may include computer code or logic having instructions that enable or cause the processing device 152 to perform various functions as described in the present disclosure for enriching or enhancing a software code base that is developed by a software developer or user in order to produce code with greater efficiency, flow, etc. and to reduce unnecessary repetitions, etc.

### Method for Enhancing Software Code

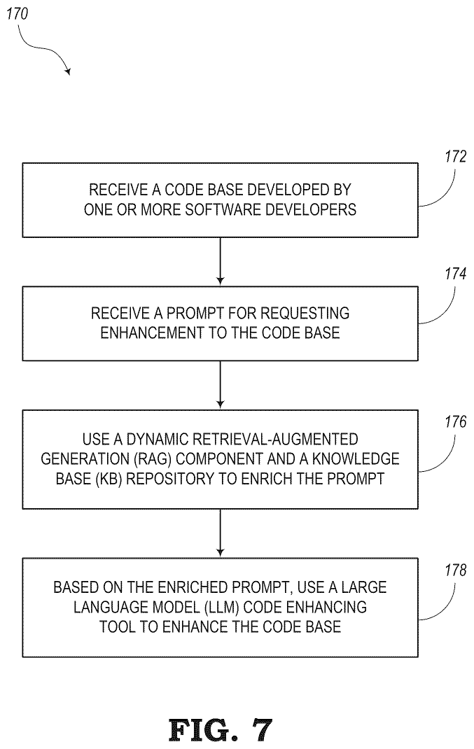

FIG. 7 is a flow diagram illustrating an embodiment of a method 170 for enhancing software code. The method 170 includes a step of receiving a code base developed by one or more software developers, as indicated in block 172. Also, the method 170 includes a step of receiving a prompt for requesting enhancement to the code base, as indicated in block 174. The method 170 further includes using a dynamic Retrieval-Augmented Generation (RAG) component and a Knowledge Base (KB) repository to enrich the prompt, as indicated in block 176. Based on the enriched prompt, the method 170 includes using a Large Language Model (LLM) code enhancing tool to enhance the code base, as indicated in block 178.

According to some embodiments, the method 170 may include a) compressing the code base enhanced by the LLM code enhancing tool and b) caching the code base in an accessible central cache. In some embodiments, the dynamic RAG component may use dynamic dependency functionality to determine relevant in-context information related to the prompt. Also, a virtual LLM (vLLM) may be configured in some implementations to assist the LLM code enhancing tool with respect to inference and memory allocation functions. The method 170 may further include a step of using an Integrated Development Environment (IDE) plugin module for assisting a user with entry of the code base and prompt.

In some embodiments, the KB may be configured to store proprietary code symbols. The dynamic RAG component, for example, may be configured to construct a code dependency tree from the proprietary code symbols during run-time and supply the code dependency tree to the LLM code enhancing tool. Additionally, the dynamic RAG component may be configured to use metadata extracted from the KB to convert the code base into an Abstract Syntax Tree (AST) and identify code symbols in the code base by querying the AST using an exact match query of the KB.

According to some implementations, the action of enhancing the code base may include a) improving readability of the code base, b) compressing or reducing redundancy of the code base, c) optimizing the code base, d) repairing the code base to reduce or eliminate errors or security issues, e) generating test automation for the code base, and/or f) creating documentation, functional explanations, and/or comments applicable to the code base. Also, the LLM code enhancing tool, in some cases, may be configured to utilize CodeLlama 34B Instruct trained with 500B code tokens.

### Code Chunking

FIG. 8 is a diagram illustrating an embodiment of a knowledge graph 180 having nested code chunks. As shown in this embodiment, each circle is a chunk, where one chunk may include one or more other chunks (e.g., nested or atomic). One module is part of a chunk 182 nested within a chunk 184 including a time_app.py and the module. This chunk 184 may be embedded in a chunk 186 further includes an SFC and time_utils.py. In this example, the chunk 186 is further embedded in a chunk 188 also including TimeUtils, requirement.txt, README.md, and another module.

Each chunk may be treated as an entity. According to one process, a first step may include generating a docstring and metadata for each entity with adequate context and storing it. For example, a Text Schema, which may be configured to enable an exact search or full text search, may include a) Source code, b) Doc String (enriched with minimal info loss)+reuse if it exists, c) Symbol type (e.g., definition, declaration, invocation), d) Function type (e.g., test code, source code, auxiliary, helper function, utils), and/or e) Metadata (e.g., special notes, doc source, API version, code deps). Also, a Vector Schema, for example, which may be configured to enable a closest search or semantic search, may include a) Source code, b) Doc String (enriched), to retrieve chunks on broader questions, and/or c) Metadata.

In a second step of the process, the system may use RAG 2.0 to produce enriched LLM-friendly docs for each node. This may include an entire code graph. A third step of the process may include a hybrid lookup. In this step, LLM can make the decision on required resolution and granularity for chunks retrieved via agents. In a fourth step of the process, the system may be configured to enable the LLM to query on the required scale. For example, this may include agents with tools that can answer the repository queries.

According to various examples, a first use case may be related to test style. In this first example, a process may include sending a Query to the Repo, “What unit test framework has been used?” A strategy may include performing a vector search on a filter of functions. The query may include looking for test code only (e.g., function type schema) with a symbol name (e.g., XYZ). A second use case may include performing a Symbol Q&A to send a Query to the Repo, “What is symbol XYZ?” A strategy may include a syntactic search of the entity with additional doc string retrieved from metadata. In a third use case, for instance, the user may have a Repo Q&A query, such as, “How can I use module ABC?” One strategy may include performing a hybrid search for an ABC definition and retrieving its information. A fourth use case, for example, may include a Repo Q&A query, such as, “How can I process a HTTP packet in zia-svn-mirror?” A Strategy, for example, may include a semantic search of <HTTP Packet> in the repo metadata and docstrings and retrieving appropriate chunks of libs, classes, and code blocks.

In a Role-Based Access Control (RBAC) system in a network security environment, RBAC may be an approach for restricting system access to authorized users and for implementing Mandatory Access Control (MAC) or Discretionary Access Control (DAC). For example, these measures may be taken to execute a plan before SQL is run. A preprocessing step may be run to filter a list of repositories that a user has access to and to perform a query based on the subset.

### Additional Rag 3.0 Features

Thus, RAG 3.0 may have a number of advantages over traditional RAG (e.g., traditional RAG, RAG 2.0, etc.). For example, traditional RAG may be slow and include manual pre-processing. For example, a vector-based retrieval for dependency in this case may be unreliable. Traditional RAG has tried to adequately perform test code style based on existing test code in theory, but has room for improvement with respect to auto repo parsing and adhering to schema for auto preprocessing as well. RAG 2.0 is an accelerator and compressor for the LLM. It can be reused to speed up I/O in further RAG models (e.g., RAG 3.0 as described herein). RAG 2.0 is configured for establishing agentic behavior, which can be a worthwhile long term investment for graph querying, knowledge from other sources, and automatically selecting the source and type of knowledge.

The following is a RAG 3.0 control flow, according to some embodiments:

### A. Processing

1. Parse Repository
   a. Identify Files
   b. Identify Programming Languages
   c. Detect code nodes
   d. Scrape refs and defs
   e. Link refs and defs
2. Push to Neo4j
   a. Extract file and function link
   b. Push to neo4j in batches
      i. Push nodes
      ii. Push files
      iii. Establish links
   c. Determine Id and index schema
   d. Index i-ii
3. Extract Dependency Information
   a. Convert link for nodes to dependency graph
      i. Digraph with n subgraphs
      ii. Split to n disconnected graphs
   b. Remove cycles
   c. Send to RAG 2 for enriched processing
      i. Convert graph to rag2 format.
      ii. Establish proper id tags for nodes
      iii. Push symbol graph list to rag service
4. Generate Docstring.
   a. Extract doc strings from rag2
   b. Attach doc string for each node.
   c. Push back to neo4j in batches
5. Embed-Embedding server launch
   a. Generate embedding for code
   b. Generate embedding for docstring
6. Push to Neo4j
   a. Tag embedding for code
   b. Tag embedding for docstring
   c. Push in batches
   d. Generate vector index
   7. Cron
   Repeat every m hours

### B. Run-Time

1. Identify appropriate vector index for query
   a. Code/doc.
   b. Tools to use
2. Generate doc embedding for input query
3. Identify symbol to search
4. Query and retrieve nodes.
5. Push nodes to LLM as context information.

### Additional Considerations

It may be noted that the implementations of the various systems and methods described in the present disclosure may have certain benefits or advantages over conventional systems and furthermore may overcome some of the shortcomings of the conventional systems described above. For example, the dynamic RAG component 32 may be configured as part of a framework for run-time prompt enrichment through dynamic dependency analysis, quick and accurate extraction of metadata from a repository (e.g., vector database 34) to improve code quality generated by the LLM code enhancing tool 30 or LLM back end 22 while also reducing or eliminating hallucinations. Also, the dynamic RAG component 32 may be configured with a processing architecture to automate prompt enrichment by quickly and precisely retrieving context of references by absolute search and cached representation in the code dependency tree based on code fingerprinting. These strategies reduce a memory footprint of retrieval augmented prompt injection, thereby speeding up the compression of the context by caching and enriching context by tree based parsing of knowledge to reduce or eliminate hallucination in code generation use cases of LLMs.

It may be noted that the embodiments of the present disclosure reduce or eliminate hallucinations that may be common in conventional systems. For example, conventional solutions attempting to overcome hallucinations were often discovered to be inaccurate and non-scalable. However, the dynamic RAG 32 shown in FIG. 1 (and other similar components described in the present disclosure) are arranged within code development systems 10, 40, 80 to overcome many of the challenges of accuracy, speed and scalability faced by the conventional systems.

GenAI may be implemented for code quality, whereby high quality code may include:
1) Readable—Follows the Language's Idioms and Naming Patterns;
2) Reusable—the code written so that it can be reused;
3) Concise—the code adheres to the DRY (don't repeat yourself) criteria;
4) Maintainable—the code is written in a way that makes the functionality clear, transparent, and relevant to the problem at hand;
5) Resilient—the code anticipates, handles, and reduces/eliminates errors; and
6) Test Coverage—the repository has adequate test coverage.

According to some embodiments, the code enhancing systems and methods may not necessarily be suitable for creating production code from scratch. Instead, the implementations described herein are usually intended for receiving code (e.g., a code base, production code, etc.) that has been prepared by a development team and then use LLM capabilities, with RAG focus, to enhance the code in certain ways. For example, upon receiving code, the systems and methods described herein may be configured for generation of test automation code, generation of code documentation, and code analysis of the code.

The dynamic RAG and other LLM back end components may be configured to write efficient prompts, analyze the codes, and prompts with great attention to detail, add sufficient details as needed, avoid typos, use clear wording, use precise wording with clear instructions. Also, the present implementations may be used, for example, on small to medium-sized input modules, which may provide the best results. For example, a recommended size may be about 1000-3000 tokens (e.g., about 250-1000 words), with a token limit of about 15,000 tokens (e.g., about 4000 words). Also, the repositories, databases, accessed files, etc. may include publicly available data, libraries, software languages, etc. that can be referenced directly. The embodiments are configured to provide necessary context at run-time for obtaining proprietary information, as determined to be applicable according to RAG functionality.

RAG 2.0 may be configured to make the code enhancement systems aware of code used in various enterprise products (e.g., Zscaler products). Also, the RAG 2.0 may retrieve relevant context on-demand for the code enhancement engines and tools and generate test code based on the retrieved dependency information.

In some embodiments, the IDE plugin 14 (and other similar IDE devices) may be configured according to various functionality. For example, one IDE plugin may include ZCoder IntelliJ Platform Plugin, which is a powerful tool that allows developers to enhance their coding experience within IntelliJ Platform IDEs. This plugin provides a range of features, including documentation, code analysis, test case generation, and custom prompts. With the code enhancement systems of the present disclosure, a user can streamline their coding process and ensure high-quality, well-documented code. This plugin may be configured to:
1. Provide Documentation: The ZCoder plugin automatically generates documentation for code, making it easy for others to understand;
2. Provide Explanations: The ZCoder can explain the functionality of the code in simpler terms;
3. Optimize the code in terms of time and space complexity;
4. Refactor the code to reusable, cleaner, and redundancy-free code;
5. Fix Security Issues, such as memory leaks and potential attack surfaces in the code;
6. Perform Code Analysis to analyze the code to identify potential issues and improves code quality, helping developers to write bug-free software;
7. Create Test Code Generation to create test cases for the code, ensuring that it behaves as expected;
8. Create Test Plan Generation to create a comprehensive test plan for the code accounting for all edge cases; and
9. Produce Custom Prompts to ask for custom prompts for the code, such as for optimizing or debugging the code.

### Conclusion

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A method comprising steps of:
receiving a code base developed by one or more software developers;
receiving a prompt for requesting enhancement to the code base;
using a dynamic Retrieval-Augmented Generation (RAG) component and a Knowledge Base (KB) repository to enrich the prompt; and
based on the enriched prompt, using a Large Language Model (LLM) code enhancing tool to enhance the code base.

2. The method of claim 1, further comprising steps of:
compressing the code base enhanced by the LLM code enhancing tool; and
caching the code base in an accessible central cache.

3. The method of claim 1, wherein the dynamic RAG component uses dynamic dependency functionality to determine relevant in-context information related to the prompt.

4. The method of claim 1, wherein a virtual LLM (vLLM) is configured to assist the LLM code enhancing tool with respect to inference and memory allocation functions.

5. The method of claim 1, further comprising a step of using an Integrated Development Environment (IDE) plugin module for assisting a user with entry of the code base and prompt.

6. The method of claim 1, wherein the KB repository is configured to store proprietary code symbols.

7. The method of claim 6, wherein the dynamic RAG component is configured to construct a code dependency tree from the proprietary code symbols during run-time and supply the code dependency tree to the LLM code enhancing tool.

8. The method of claim 7, wherein the dynamic RAG component is configured to use metadata extracted from the KB repository to convert the code base into an Abstract Syntax Tree (AST) and identify all referenced code symbols by querying the AST, and construct a code dependency tree with each symbol as a node, along with its definition retrieved via Language Server Application Programming Interfaces (APIs).

9. The method of claim 1, wherein enhancing the code base includes one or more of a) improving readability of the code base, b) compressing or reducing redundancy of the code base, c) optimizing the code base, d) repairing the code base to reduce or eliminate errors or security issues, e) generating unit test code automation for the code base, and f) creating documentation, functional explanations, and/or comments applicable to the code base.

10. The method of claim 1, wherein the LLM code enhancing tool is configured to utilize CodeLlama 34B Instruct trained with 500B code tokens.

11. A system comprising:
a processing device; and
a memory device configured to store a computer program having instructions that, when executed, enable the processing device to
receive a code base developed by one or more software developers,
receive a prompt for requesting enhancement to the code base,
use a dynamic Retrieval-Augmented Generation (RAG) component and a Knowledge Base (KB) repository to enrich the prompt, and
based on the enriched prompt, use a Large Language Model (LLM) code enhancing tool to enhance the code base.

12. The system of claim 11, wherein the dynamic RAG component uses dynamic dependency functionality to determine relevant in-context information related to the prompt.

13. The system of claim 11, wherein a virtual LLM (vLLM) is configured to assist the LLM code enhancing tool with respect to inference and memory allocation functions.

14. The system of claim 11, further comprising an Integrated Development Environment (IDE) plugin module for assisting a user with entry of the code base and prompt.

15. The system of claim 11, wherein the KB repository is configured to store proprietary code symbols.

16. The system of claim 15, wherein the dynamic RAG component is configured to construct a code dependency tree from the proprietary code symbols during run-time and supply the code dependency tree to the LLM code enhancing tool, and wherein the dynamic RAG component is configured to use metadata extracted from the KB repository to convert the code base into an Abstract Syntax Tree (AST) and identify code symbols in the code base by querying the AST using an exact match query of the KB repository.

17. A non-transitory computer-readable medium configured to store computer logic having instructions that, when executed, cause one or more processing devices to:
receive a code base developed by one or more software developers;
receive a prompt for requesting enhancement to the code base;
use a dynamic Retrieval-Augmented Generation (RAG) component and a Knowledge Base (KB) repository to enrich the prompt; and
based on the enriched prompt, use a Large Language Model (LLM) code enhancing tool to enhance the code base.

18. The non-transitory computer-readable medium of claim 17, wherein the dynamic RAG component uses dynamic dependency functionality to determine relevant in-context information related to the prompt, wherein a virtual LLM (vLLM) is configured to assist the LLM code enhancing tool with respect to inference and memory allocation functions, and an Integrated Development Environment (IDE) plugin module assists a user with entry of the code base and prompt.

19. The non-transitory computer-readable medium of claim 17, wherein the KB repository is configured to store proprietary code symbols, wherein the dynamic RAG component is configured to construct a code dependency tree from the proprietary code symbols during run-time and supply the code dependency tree to the LLM code enhancing tool, and wherein the dynamic RAG component is configured to use metadata extracted from the KB repository to convert the code base into an Abstract Syntax Tree (AST) and identify code symbols in the code base by querying the AST using an exact match query of the KB repository.

20. The non-transitory computer-readable medium of claim 17, wherein enhancing the code base includes one or more of a) improving readability of the code base, b) compressing or reducing redundancy of the code base, c) optimizing the code base, d) repairing the code base to reduce or eliminate errors or security issues, e) generating test automation for the code base, and f) creating documentation, functional explanations, and/or comments applicable to the code base.
